(19) United States
(12) Patent Application Publication
(10) Pub. No.: US 2018/0151091 A1
(43) Pub. Date: May 31, 2018

(54) OPEN SEASONS STOP AND GO ADVISORY FOR SPORTS EVENTS

(71) Applicant: Steve A. Werch, Neshkoro, WI (US)

(72) Inventor: Steve A. Werch, Neshkoro, WI (US)

(21) Appl. No.: 15/810,623

(22) Filed: Nov. 13, 2017

Related U.S. Application Data
(60) Provisional application No. 62/427,552, filed on Nov. 29, 2016.

(51) Int. Cl. G09B 29/00; G01W 1/06

(52) U.S. Cl. CPC G09B 29/007; G01W 1/06; H04M 2242/28; H04M 2242/14; H04M 2242/30; H04M 2242/15

(57) ABSTRACT

A system for providing information to a user regarding a sports event like fishing, hunting or trapping with respect to change in a time zone of a location is provided. The system includes a memory for storing account information and previous event history of the user, one or more processors for determining sports event available for the user, determining locations of sports event nearby the user location, and communicating the data to the user mobile electronic device to display in a display of the mobile electronic device the one or more event information and their time in a user selected time zone. The display is further configured to display the status/warning (open or close) of the sports event in the user selected time zone along with a location map showing a frequency of plurality of users visiting the sports event.

### CROSS REFERENCE TO RELATED APPLICATIONS

This application claims priority to U.S. Provisional Patent Application No. 62/427,552 filed on Nov. 29, 2016, which is incorporated herein in its entirety by reference.

### FIELD

The present disclosure relates to application software for cellphones for sports event alert, more particularly to a cell phone application that provides information regarding sports event like fishing or hunting.

### BACKGROUND OF THE DISCLOSURE

Event alerting system is used by the government and non-government agencies for providing information to the public about a particular type of event going to happen in a particular location. Various types of desktop and mobile based software are used for this purpose. Events that happen after a threshold period of time like fishing, hunting, and trapping in a particular area also need to be tracked, and updated information should be available to the public.

Various attempts have been made to solve these problems. A number of different types of methods for providing sports event information to a person are available in prior art.

U.S. patent application Ser. No. 13/793,909 issued to Open Disclosure Network, Llc discloses a system, method, and computer readable medium for providing information to a mobile electronic device based on an event comprising detecting an occurrence of the event, determining if the event is a specific event and if the event occurred at or near a geographical location and sending an alert of the event to at least one mobile electronic device if the event is the specific event, if the event occurs at or near the geographical location, or if the at least one mobile electronic device is located at or near the geographical location.

U.S. patent application Ser. No. 13/938,460 issued to Marc HOSEIN, Steve Yankovich, Nate LYMAN, Selina Lam shows Systems and methods for providing an enhanced user experience at an event or venue. The systems and methods discuss venue-specific location-based services to the user through the user's mobile electronic device. U.S. patent application Ser. No. 13/645,675 issued to Google Inc. relates to a computing device may determine a geographic location of the computing device. The computing device may receive information associated with a user. The information may include a search history, a browsing history, an electronic communication message, a social media profile, and a geographic location history.

These examples of the art disclose a system that provides information about an event to a person. However, change in timing of an event with a change in a time zone of the person is not informed. Therefore, there is a need for a system that can provide timing of opening and closing of a particular type of event in a particular location with respect to the change in the time zone of the person.

### SUMMARY

Embodiments of the disclosure relates to an application software for cellphones for sports event alert, more particularly to a cell phone application that provides information regarding sports event like fishing, hunting and trapping with respect to a change in time zone.

In an example embodiment, system provides correct timing of opening and closing of sports event like fishing, hunting, and trapping of a location belonging to a different time zone from that of a time zone of a person or a user.

In an example embodiment, a computer-implemented system for providing information to a user regarding a sports event comprises a memory and processor, the memory including a non-transitory computer-readable-medium having computer-executable instructions stored therein that, when executed by the processor, cause the processor to, receive the current location information of a mobile electronic device associated with a user from a global positioning system (GPS) embedded in the mobile electronic device; send the current location information of the mobile electronic device to a remote server, the remote server being configured to determine one or more sports event information associated with the current location or nearby locations and corresponding time information for each of the sports event in a user selected time zone; receive the one or more sports event information along with the corresponding time from the remote server; and display in a display of the mobile electronic device the one or more sports event information and their time in the user selected time zone.

According to an example embodiment, the user selected time zone is a time zone inputted by the user during an online account registration.

According to an example embodiment, the one or more sports event information along with the information indicating whether the sports event is closed or open in the user selected time zone, is displayed by the mobile electronic device.

According to an example embodiment, the user selected time zone is different from the local time zone of the current location of the mobile electronic device.

According to an example embodiment, the processor is configured to send, to the display, the current location information of the user be displayed on the display.

According to an example embodiment, the display is configured to display the closed or open status of the sports event up-to-an accuracy of a minute.

According to an example embodiment, the user selected time zone is a one single time zone and is automatically determined by the mobile electronic device.

According to an example embodiment, the one single time zone is automatically determined by the mobile electronic device based on a threshold time spent by the user mobile electronic device in a time zone. For example, if a user has spent one month in one time zone (i.e. in time zone A and enters in another time zone-time zone B for hunting and spends 2 hours in the time zone B. and then enters time zone C, then time zone A is the user time zone based on the use spending time in the time zone A. Alternatively, the user may specifically select his time zone by assigning a time zone online.

According to an example embodiment, the processor is further configured to, receive boundary information corresponding to the sports event area from the server and the user position from the GPS and display the sports event area and boundaries with respect to the user position. The boundaries include boundary lines based on time zone.

According to another example embodiment, boundaries include boundaries defined by the state or county management (i.e. boundary lines for sates, county or city limits) so that the law or rule based on state or local level is followed.

According to an example embodiment, the processor is configured to send the previously visited sports event to be displayed on the display, order of the display being based on timeline of the visit and location of the visit.

According to an example embodiment, the previously visited sports events are displayed on the display in a graphical or in tabular format.

According to an example embodiment, the sports event area includes at least one of the hunting area, fishing area, wildlife refuge area, fish refuge area, and any other boundary or zone that are conservation area.

According to an example embodiment, the closed status is displayed in red and open status is displayed in green colors.

According to an example embodiment, the alert status is displayed in yellow two minutes prior to the closing or opening.

According to an example embodiment, the color status is changed automatically based on the opening or closing of the sports event.

It is to be understood that the disclosure is not limited in its application to the details of construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

These together with other objects of the disclosure, along with the various features of novelty which characterize the disclosure, are pointed out with particularity in the disclosure. For a better understanding of the disclosure, its operating advantages and the specific objects attained by its uses, reference should be made to the accompanying drawings and descriptive matter in which there are illustrated preferred embodiments of the disclosure.

### BRIEF DESCRIPTION OF THE DRAWINGS

The example embodiments of the inventive concept will be better understood from the following brief description taken in conjunction with the accompanying drawings. The drawing FIGS. 1-9 represent non-limiting, example embodiments.

FIG. 1 illustrates a user interface of the application software providing visual alerts to the mobile electronic device, according to an example embodiment;

FIG. 2 illustrates another user interface of the application software, according to an example embodiment;

FIG. 3 illustrates time of hunting in different time zones, according to an example embodiment;

FIG. 4 illustrates time of hunting in a particular time zone displayed on the screen of a mobile electronic device, according to an example embodiment;

FIG. 5 shows various components of an example embodiment wherein database server and mobile electronic device location database are shown:

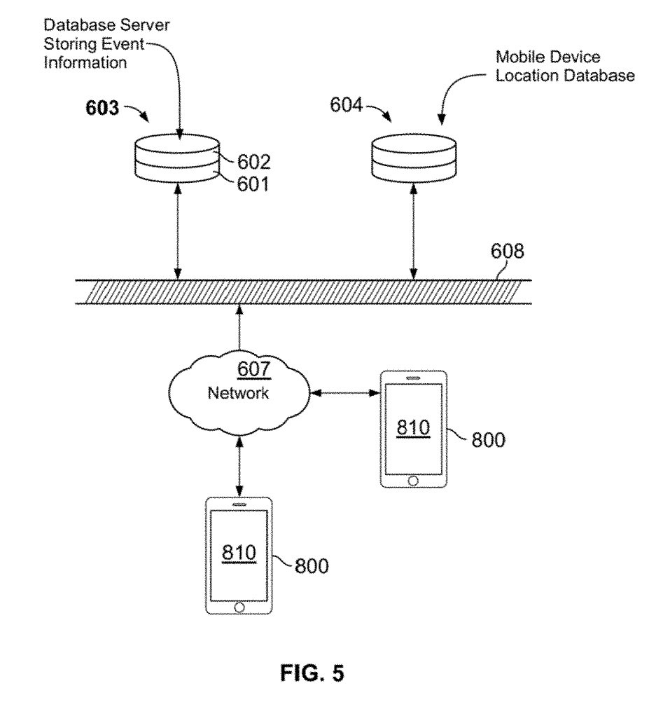

FIG. 6 shows various components of an example embodiment wherein a global and local sports event database are shown for storing and using data more efficiently;

FIG. 7 shows various components and interconnections of an example embodiment in a mobile electronic device according to an example embodiment;

FIG. 8 shows various the current and nearby locations of the plurality of mobile electronic devices around the user's mobile electronic device, according to an example embodiment; and

FIG. 9 shows close-up (street level) view of the position of a user (hunter) displayed in the display of the user's mobile electronic device, according to an example embodiment.

### DETAILED DESCRIPTION OF THE DISCLOSURE

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein: rather, these embodiments are provided so that this disclosure will be thorough and complete, and will fully convey the concept of example embodiments to those of ordinary skill in the art. In the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

It will be further understood that some terminology such as “user”, “person”, or “customer” are used interchangeably. Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

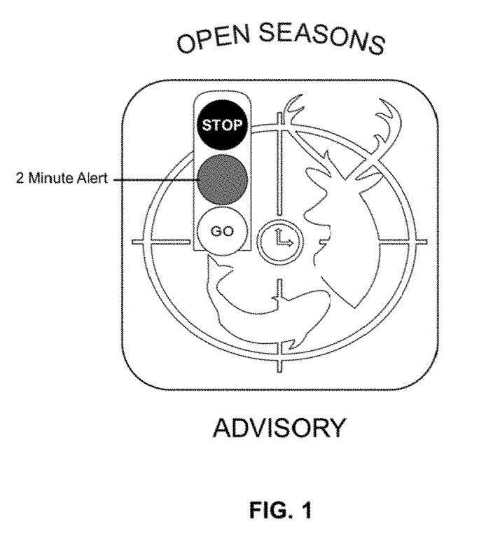

FIG. 1 shows a warning sign displayed in a graphical user interface of a mobile electronic device. STOP indicates that the area is not legally open for hunting, fishing or other sports event. Such sign may be displayed in red. GO indicates that the area is legally open for hunting, fishing or other sports event. Such sign may be displayed in green.

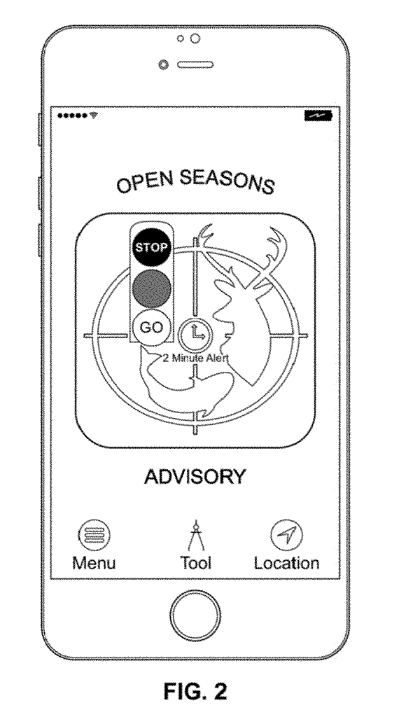

FIG. 2 shows a user interface of the application software indicating a zone in the mobile electronic device, according to an example embodiment.

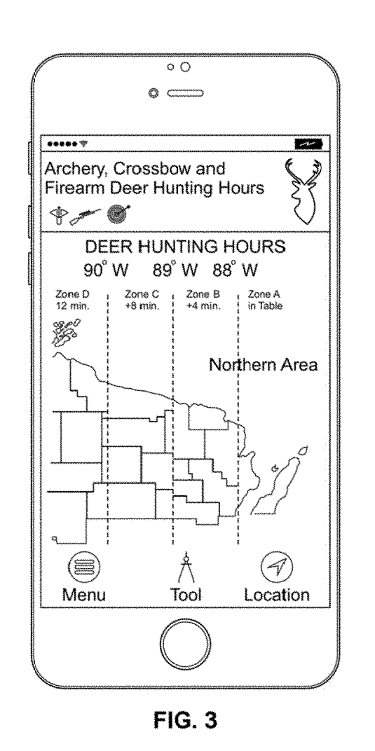

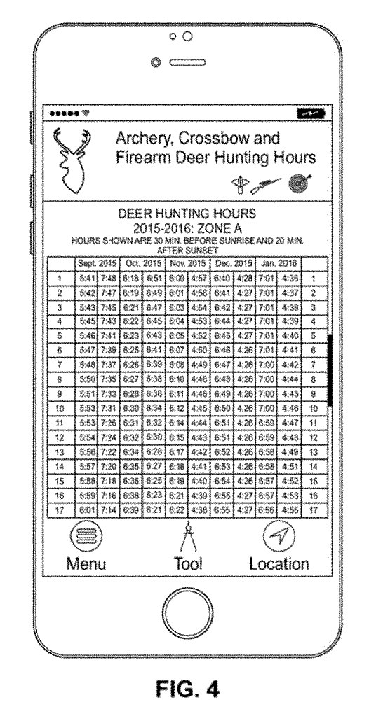

FIG. 1-FIG. 4 illustrate a graphical user interface of the mobile electronic device, according to an example embodiment. A user by logging into the software application can connect to a remote server and data can be retrieved from the remote server by using the internet. Regular updating is required at the remote server about any changing in time, zone and sports law of the particular location. A user can retrieve information about the hunting of deer in different time zone as shown in FIG. 3 and time-related information in that particular time zone for deer hunting as shown in FIG. 4. Present location of the user can also be displayed on the screen of the mobile electronic device by using GPS (global positioning system) locator. Previous history and already visited events by the user can also be retrieved.

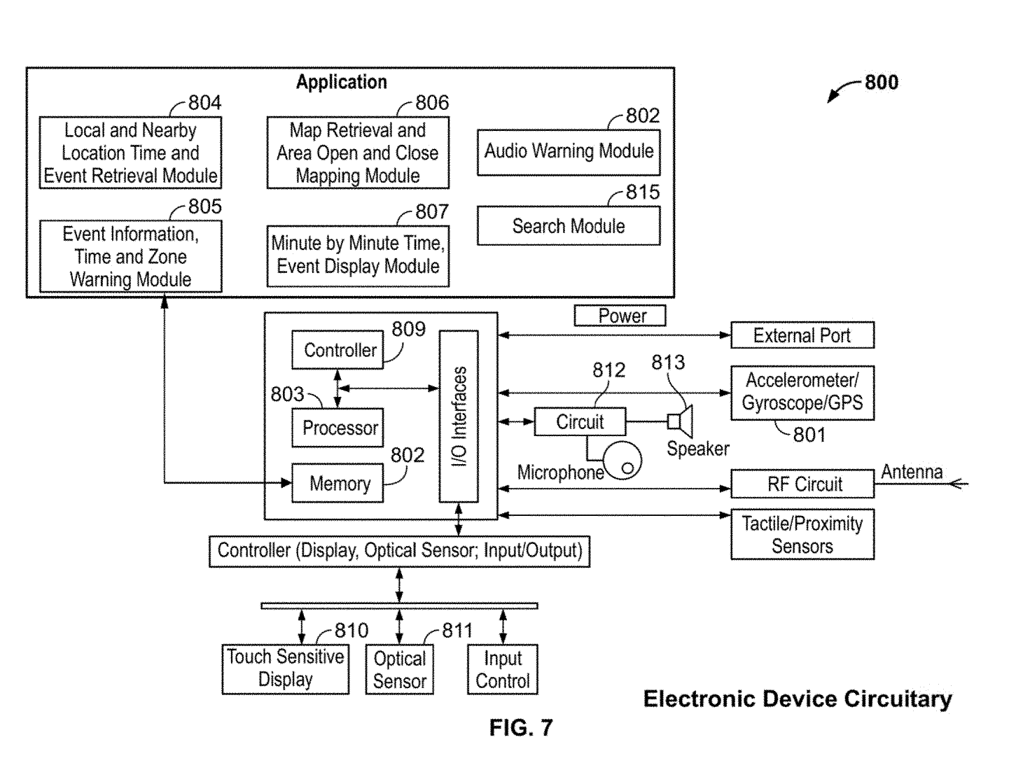

FIG. 7 shows a computer-implemented system of a mobile electronic device 800 for providing information to a user regarding sports event including fishing or hunting. The system comprises a memory 802 and processor 803, the memory including a non-transitory computer-readable-medium having computer-executable instructions stored therein that, when executed by the processor, cause the processor to, receive current location information of the mobile electronic device 800 from a global positioning unit (GPS) 801 embedded in the mobile electronic device; and send the current location information of the mobile electronic device to a remote server 703. The remote server 703 is configured to determine one or more event information associated with the current location or nearby locations of the user and corresponding time information for each of the events in a user selected time zone. The processor 803 receives the one or more event information along with the corresponding time from the remote server 703 via network 607 and displays in a display 810 of the mobile electronic device 800, the one or more event information and their time in a user selected time zone.

In an example embodiment, the remote server 703 includes global event database 704 storing events and associated data with locations and time globally. For example, server 704 is configured to store events associated with locations and time of all 50 states of USA.

In an example embodiment, the remote server 703 further includes a local event database 705 storing events and associated location and time locally. For example, this database stores the filtered data for nearby and surrounding locations where the mobile electronic device 800 is currently located so that as the mobile electronic device moves, the processor only needs to search through the database 705 to identify location and event information for fast data retrieval and communication to the mobile electronic device 800.

In an example embodiment, the remote server 703 includes memory 701 having computer-executable instructions stored therein that, when executed by the processor 702, causes the processor to, receive current location information of the mobile electronic device and determine one or more event information associated with the current location or nearby locations of the user and corresponding time information for each of the events in the user selected time zone.

In another example embodiment, a remote server 603 is connected to another database server, the mobile database server 604 including location information of the mobile electronic devices. As the mobile electronic device 800 is moving in various location or zones, the GPS module of the mobile electronic device sends the location information to the mobile electronic device location database server 604 via network 607. Such mobile electronic device database server 604 can be used to efficiently store and retrieve the location data of the mobile electronic devices while providing event services to a larger number of mobile electronic devices.

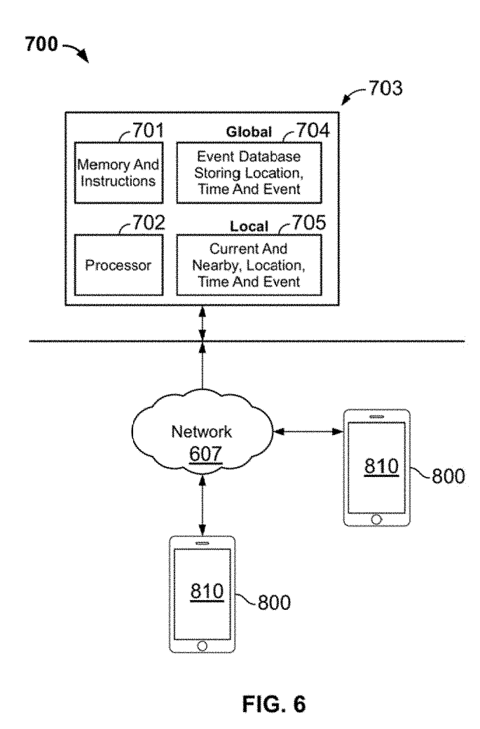

FIG. 6 shows various components of an example embodiment wherein a global database 704 and local event database 705 may be used for storing and using data more efficiently. Such databases may be connected to the mobile electronic device via the network 607. In an example embodiment, local event database may be a different memory location in the same sever.

Further, FIG. 7 shows various components in the mobile electronic device 800. The memory 802 includes a non-transitory computer-readable-medium having computer-executable instructions stored therein that, when executed by the processor 803, causes the processor to receive current location information of the mobile electronic device 800 associated with a user from a global positioning system (GPS) module 801 embedded in the mobile electronic device.

The processor 803 uses the local and nearby location time and event retrieval module 804, event information, time and zone warning/indicator module 805, Map retrieval and area status (open/close) indication module 806, minute by minute time and event indication module 807, audio warning module 808, search module 815 to execute the various functions. For example, local and nearby location, time and event retrieval module 804 instructs the processor 803 to send the current location information of the mobile electronic device 800 to the mobile electronic device location database server 604. The server 603 retrieves the location information and determines one or more event information associated with the current location and nearby locations and corresponding time information for each of the events in a user selected time zone and sends this information to the processor 803 via network 607. The processor then stores this information in a memory and displays the one or more event information and their time in the user selected time zone in the display 810 of the mobile electronic device 800.

In an example embodiment, map retrieval and area status and area mapping module 806 instructs the processor 803 and controller 809 to retrieve the map associated with the event, time data and time zone from the remote servers.

In an example embodiment, the processor 803 and controller 809 are configured to send, to the display, the current location information of the user to be displayed on the display 810.

The processor 803, based on the location of the user mobile electronic device displays the one or more event information along with the information indicating whether the event is closed or open in a user selected time zone. In an example embodiment, the user selected lime zone is the time zone that the user has inputted during online registration of the account receiving the service to use the application in the mobile electronic device. In another example embodiment, such time zone is a time zone that is automatically determined by the mobile electronic device 800. In yet another example embodiment, such time zone is automatically determined by the mobile electronic device based on a threshold time spent by the user mobile electronic device in a time zone. For example, if a user is in Virginia and mobile electronic device spends more time in US EST than US EST is the time zone determined by the device and event is indicated in the US EST time zone. Such threshold time spent by the user is the time value inputted by the user during the application purchase/registration. In another example embodiment, such time zone is the time zone prior to entering the new time zone by the user. Displaying the warning sign or operating hours in the user time zone in which the user is comfortable and is currently following can help to follow season times accurately and avoid breaking the law and being cited causing possible fines and confiscations.

In an example embodiment, the processor 803 determines the operating time zone (i.e. whether the events such as hunting, or fishing etc.) is still valid and converts the operating time zone into the user comfortable time zone and displays a warning sign. Such warning sign is shown in FIG. 1. In another example embodiment, the audio warning module 808 in the electronic mobile electronic device causes processor 803 to send instructions to generate alert signal such as sound or vibration via speaker 813 to warn the user.

In an example embodiment, the user selected time zone is a time zone inputted by the user in the server during an online account registration for installing the application to receive the sports event services.

In another example embodiment, the warning signs in the electronic display to displays the closed or open status of the event can be generated up-to-an accuracy of a minute.

FIG. 3 shows a map displayed in the mobile electronic device which displays the changing hunting hours because of the change in time zone in increment/decrement of 4 minutes. For example, when a user enters from zone D to Zone C, the display will automatically indicate the hunting timing closing 4 minutes early as compared to the zone D and closing time will be displayed in the users' time zone accordingly. In an example embodiment, an alert or warning to the user is displayed in yellow color two minutes prior to the closing or opening of a zone.

In another example embodiment, the alert status as represented by the color is automatically changed based on the opening or closing of the event. For example, the alert will change from green (still open) to yellow (will be closed in 2 minutes) to red (closed).

In an example embodiment, the module 806 causes the processor receive boundary information corresponding to the event area from the server 703 based on the user position from the GPS 801 and displays the event area and boundaries with respect to the user position.

In an example embodiment, the modules—nearby location time and event retrieval module 804, event information, time and zone warning module 805, map retrieval and area status indication module 806, minute by minute time and event indication module 807, audio warning module 808, search module 809 are applications saved in a memory 802 that is operatively connected to the processor for the execution of the instructions by the processor.

In an example embodiment, the display unit of the mobile electronic device is configured to display information in graphical as well as in tabular format. The GPS (global positioning system) locator is embedded in mobile electronic device and is capable of sending signals indicative of a present location of the user.

According to the present disclosure, the system will guide the person using it by showing them up-to-the-minute where ever they are by GPS if the hunting or fishing season they are participating in is open or closed. Some states have fish and game seasons that open and close within a certain amount of time daily before or after sunrise or sunset. They differ from each other in one way or another. Also, some states have time zones that are based on longitude parallels that have different start and close times because the sun rises and sets later as a user goes to west. It is about four minutes later for each parallel travel to the west. Also, the sun rises and sets earlier or later every day because of the changing length of daylight hours. This fact changes legal fishing and hunting hours on a daily basis. This system is configured to show these boundaries and user position in a zone and if legal hunting and fishing hours are open or closed up-to-the-minute by the zone being displayed as red for closed or green for open or yellow for two (2) minutes prior to opening and/or closing. These will change from one color to the other automatically as the zone either opens or closes by the time of that day.

According to the present disclosure, the system will automatically change to show a red or green color in those zone's as they open (green), alert (yellow) two (2) minutes prior to opening and/or closing giving a user an advantage to be ready for one or the other, and close (red) each and every day at opening and closing time.

In an example embodiment, the alert may be in human voice indicating that the zone will be closed after certain time, or the alert may be in vibration pattern signaling the user that the hunting time has ended.

This will enable a user to follow season times legally and eliminate breaking the law and being cited causing possible fines and confiscations or even worse. It will also show location of a user by distinguishing private and public property with different colors showing boundaries and eliminating unknowingly trespassing. With this system, one will be able to know where and when hunting trapping and fishing seasons open and close without question wherever the user is.

In an example embodiment, the mobile application provides a visual indication in the mobile electronic device that a user is about to enter a zone. The visual indication includes a brief description of the zone, boundary of the zone and other parameters associated with the zone. The mobile application further provides an indication that the given zone is open, closed or about to open or close to the public. This application is particularly useful when entering into invisible boundaries including wildlife refuge, fish refuge, or any other boundary or zone that are important conservation area.

In another example embodiment, the application is designed to differentiate between the private and public property and provide a visual indication accordingly.

In yet another example embodiment, a system is provided which is configured to update the data available to a user based on his previous history of sports events and providing optional sports events available for the user in response to a user request to process and provide such information.

In another example embodiment, the remote server 603 is configured to determine a plurality of mobile electronic devices in the current or nearby location of another mobile electronic device by using the location information received from the plurality of the mobile electronic devices. This information is stored in mobile location database server 604. The database server 604 uses this location information of the plurality of mobile electronic devices along with the time of visit in the current or nearby location of another mobile electronic device and generates a map and sends to the mobile electronic device 800 to be displayed on the display of the mobile electronic device 800.

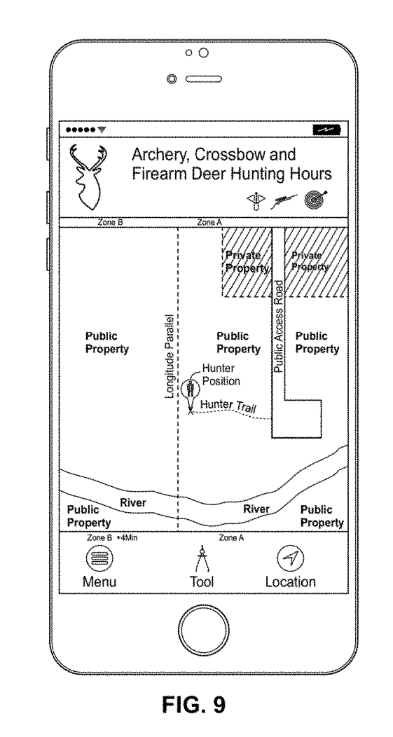

In FIG. 9; P, Q, R, S, T, U, V, W, X are the current and nearby locations of the plurality of mobile electronic devices around the user's mobile electronic device location. For example, A is the current location of the mobile electronic device 800 under consideration, and P, Q, R, S, T, U, V, W, X are the nearby locations of the mobile electronic devices of the other users.

In an example embodiment, region 901 shows more dense user events activity area as compared to the nearby regions. Region 902 is less dense user events activity area.

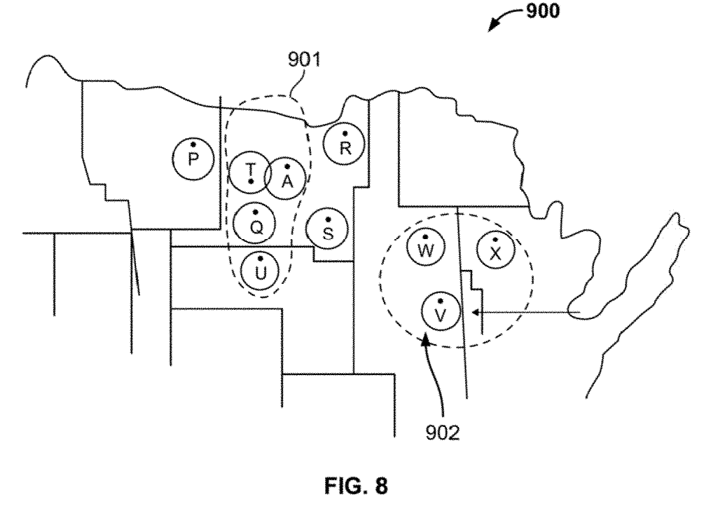

In an example embodiment, FIG. 8 shows location map with density of user events activity. In FIG. 8, the density of the user activity is shown in the location map as a frequency of plurality of users visiting the sports event and corresponding visited spots in the current location and nearby locations of the mobile electronic device in a period of time. Such period of time used to calculate the density of user events may be a period of time in a specific time of the year. For example, if a user is visiting the sports event in March 21, then a time period of March 7-April 7 of the year may be considered as the time period to determine the density of the user activity. In another example embodiment, such time period may be weeks, months, or even years or several years. In an example embodiment, the density of the users can be the number of users per square miles.

In an example embodiment, the user's position is displayed in the mobile electronic device in a close-up view so that the user can see if he is about to cross from one time zone to another time zone (for example, from zone A to zone B in FIG. 9). Such close-up view can be within an accuracy of 2 meters. When a user is approaching to the longitudinal parallel as shown in FIG. 9, the mobile electronic device displays a warning sign that the user is just 3 m away from the longitudinal parallel line and time zone is about to change by +4 minute. In an example embodiment, the user can change the mode of display by simply clicking a single button to display his position with respect to the nearest boundary as shown in FIG. 9.

The system of the present disclosure provides a correct time of fishing, hunting and trapping to the user at a particular location. In addition, this will enable a user to follow season times legally and eliminate breaking the law and being cited causing possible fines and confiscations or worse.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

1. A computer-implemented system for providing information to a user regarding a sports event, the system comprising:
a memory and processor, the memory including a non-transitory computer-readable-medium having computer-executable instructions stored therein that, when executed by the processor, cause the processor to,
receive current location information of a mobile electronic device associated with a user from a global positioning system (GPS) embedded in the mobile electronic device;
send the current location information of the mobile electronic device to a remote server, the remote server being configured to determine one or more sports event information associated with the current location or nearby locations and corresponding time information for each of the sports event in a user selected time zone;
receive the one or more sports event information along with the corresponding time from the remote server; and
display in a display of the mobile electronic device the one or more sports event information and their time in the user selected time zone.

2. The system of claim 1, wherein the user selected time zone is a time zone inputted by the user in the server during an online account registration.

3. The system of claim 2, wherein the processor is further configured to cause the display to display the one or more sports event information along with the status information indicating whether the sports event is closed or open according to the user selected time zone.

4. The system of claim 2, wherein the user selected time zone is different from the local time zone of the current location of the mobile electronic device where the sports event is available.

5. The system of claim 2, wherein the processor is further configured to send, to the display, the current location information of the user to be displayed on the display.

6. The system of claim 3, wherein the closed or open status of the sports event is displayed up-to-an accuracy of a minute.

7. The system of claim 3, wherein the user selected time zone is a one single time zone and is automatically determined by the mobile electronic device.

8. The system of claim 3, wherein the one single time zone is automatically determined by the mobile electronic device based on a threshold time spend by the user mobile electronic device in a time zone.

9. The system of claim 3, wherein the processor is further configured to,
receive boundaries corresponding to the sports event area from the server and the user position from the GPS and display the sports event area and boundaries with respect to the user position.

10. The system of claim 3, wherein the processor is configured to send previously visited sports event to be displayed on the display, order of the display being based on timeline of the visit and locations of the visit.

11. The system of claim 3, wherein the processor is further configured to send data for street level view of the user position to cause the display to display and indicate that the user is about to cross from one time zone to another time zone or is about to enter a public or private property.

12. The system of claim 10, wherein the previously visited sports event are displayed on the display in a graphical or in tabular format.

13. The system of claim 10, wherein the sports event area include at least one of hunting area, fishing area, wildlife refuge area, fish refuge area, and any other boundary or zone that are conservation area.

14. The system of claim 11, wherein in response to the user selection of a single touch button, the processor is configured to send data for street level view of the user position to cause the display to display and indicate that the user is about to cross from one time zone to another time zone or is about to enter a public or private property.

15. The system of claim 13, wherein closed status is displayed in red and open status is displayed in green color.

16. The system of claim 13, wherein the alert status is displayed in yellow two minutes prior to the closing or opening.

17. The system of claim 13, wherein the status information indicating whether the sports event is closed or open is vibration alert presented two minutes prior to the closing or opening.

18. The system of claim 13, wherein the status information indicating whether the sports event is closed or open is an alert presented in human voice.

19. The system of claim 15, wherein the color status is changed automatically based on the opening or closing of the sports event.

20. A computer-implemented system for providing information to a user regarding a sports event, the system comprising:
a memory and processor, the memory including a non-transitory computer-readable-medium having computer-executable instructions stored therein that, when executed by the processor, cause the processor to,
receive current location information of a mobile electronic device associated with a user from a global positioning system (GPS) embedded in the mobile electronic device;
send the current location information of the mobile electronic device to a remote server, the remote server being configured to,
determine one or more sports event information associated with the current location or nearby locations and corresponding time information for each of the sports event in a user selected time zone;
send data associated with a location map for showing a frequency plurality of users visiting the sports event and corresponding visited spots in the current location and nearby locations of the mobile electronic device to the mobile electronic device;
receive the one or more sports event information along with the corresponding time from the remote server; and
display in a display of the mobile electronic device the one or more sports event information and their time in the user selected time zone and the location map.
